(19) United States
(12) Patent Application Publication
(10) Pub. No.: US 2009/0201372 A1
(43) Pub. Date: Aug. 13, 2009

(54) METHOD AND APPARATUS FOR INTEGRATED ATM SURVEILLANCE

(75) Inventors: Phelim Anthony O'Doherty, Dublin (IE); Sean David McCarthy, Dublin (IE); Patrick Joseph Smith, Dublin (IE); Carlos Luna, Dublin (IE); John Joseph O'Kane, Co Wicklow (IE); Fergus Taylor, Co Sligo (IE); Wayne Kearns, Co Wicklow (IE); Roger Hatfield, Dublin (IE)

Correspondence Address: SEYFARTH SHAW LLP, WORLD TRADE CENTER EAST, TWO SEAPORT LANE, SUITE 300, BOSTON, MA, 02210-2028, US

(73) Assignee: Fraudhalt, Ltd., Dudlin (IE)

(21) Appl. No.: 12/428,221

(22) Filed: Apr. 22, 2009

Related U.S. Application Data
(63) Continuation-in-part of application No. 11/705,280, filed on Feb. 12, 2007, now abandoned.
(60) Provisional application No. 60/772,623, filed on Feb. 13, 2006.

(51) Int. Cl. H04N 7/18

(52) U.S. Cl. 348/150; 348/E07.085

(57) ABSTRACT

A method and apparatus for integrated ATM surveillance of an area of interest, such as an automated teller machine (ATM), is presented. An embodiment includes a surveillance system for an ATM utilizing multiple cameras aimed at the user, the card slot, the cash dispenser, the surrounding areas and internally in the card reader (to link the card used to the ATM user). The cameras are constantly powered and begin to record images after a sensor is activated. A buffer of recorded imagery is maintained such that when the sensors are activated, the video processing equipment can store a pre-defined amount of time before the sensor is activated. The buffer allows for the video capture of events just prior to the activation of the sensor. A time stamp and any other relevant data from the cameras may also be included with the stored recorded video.

### FIELD OF INVENTION

The present invention relates to video processing, more particularly, to a method and apparatus for integrated ATM surveillance.

### BACKGROUND OF INVENTION

Automatic Teller Machines (ATMs) are vulnerable to a variety of fraudulent attacks designed to withdraw money illegitimately. These attacks include direct attacks on the ATM itself, as well as attacks that occur on the user in and around the environment of the ATM. Additionally, there are ATM customer reported incidents that may be fraud, or may be a genuine mistake by the customer. Incidents in the latter category may not directly relate to the ATM customer, but rather to a family member, colleague, or friend.

Direct attacks on an ATM may occur in a variety of ways including, but not limited to, the unauthorized use of genuine cards, the process of hijacking a normal transaction, skimming, or the use of counterfeit or cloned cards.

The unauthorized use of genuine cards may vary from use by a family member or colleague, to an unknown third party who has stolen a user's ATM card. Unfortunately, many people tend to keep the pin numbers for their ATM cards in close proximity to the card itself. For example, people often write their pin number on a piece of paper and keep it in their wallets or purses. Alternatively, some people may even write their pin number on the card itself, which makes it easy to attack the customer's account. Ultimately the card owner is the person who loses out as they may be responsible for the monetary losses incurred by this type of attack because it may be very difficult to prove that someone used their card without their approval.

Another type of direct attack may take place when a criminal begins, or interrupts, a normal transaction, but manipulates the transaction in order to dupe the ATM into believing that the transaction was faulty, thereby causing the ATM to re-credit the account and terminate the transaction. This may be accomplished in a variety of ways including, but not limited to, manipulating the cash drawer or by removing only those bank notes in the middle of the cash delivered by the ATM. This type of direct attack is normally only discovered long after the criminal has escaped with the cash.

Yet another type of direct attack is known as skimming, which involves compromising the ATM so that it fraudulently collects user's card details even while the ATM continues to operate. Fake ATM cards may then be encoded with the collected details and used to withdraw money from the compromised ATM, or other ATM within the user's ATM network.

The weakness in the ATM's operation that allows this fraud to work is the exclusive reliance on the card's magnetic stripe. Other features of the card are not checked, making this a quick and simple fraud to perpetrate with bank cards that contain a magnetic stripe. The fraud also relies upon deceiving the user into believing that the ATM is operating normally, by camouflaging whatever means has been employed to skim the user's information.

Typically the magnetic stripe data of a card is read fraudulently by placing a card-reader over the ATM's card-insert slot. Cards pass through the added reader on their way into the slot, and it records a copy of the magnetic stripe data. From the user's point of view the ATM functions normally. At some later point, the perpetrator may recover the added reader which now contains details of all the cards that have been used in the ATM. These details may be downloaded from the reader and used to create ‘cloned’ ATM cards, which may then be used in an ATM as if they were the real thing. In this way the crime yields untraceable hard currency for its perpetrator before the victim is even aware that a crime has occurred.

An even safer option for the criminal is to use a wireless link to transmit card details from the magnetic stripe reader to a nearby receiver, removing the risk of returning to the ATM to recover the reader. In either case, a collection of blank magnetic stripe cards may be quickly written with the gathered data to be used immediately to withdraw cash; the whole operation can be carried out in a day, with the perpetrators moving on to a different ATM to repeat the operation.

However, there is one major hurdle to be overcome in these types of direct attack: the ATM user must enter a PIN to authorize use of the card. The criminal must either acquire or deduce the card's PIN in order to use it. It turns out that a PIN can be deduced from the magnetic stripe data, as it must be for an ATM to operate in a stand-alone mode, although it is not common for this to be attempted by criminals. Instead an additional reading device is used to compromise the number keypad of the ATM, to capture the user's PIN as it is entered during use. There are two main approaches for PIN capture. One is to video the PIN entry, using a miniature camera connected to a recording device or transmitting wirelessly. The movements of the user's fingers over the keypad can then be viewed to determine the PIN. The other is to affix a fake keypad over the genuine one, with keys that push through to the real pad. The fake keypad records key presses in memory, so they can be recovered along with the magnetic stripe reader. Again, the user does not notice the fake and the ATM operates normally.

These types of direct attack are highly successful, thanks to relative simplicity and the difficulty of catching them in operation. Once committed, the criminals immediately have actual money, unlike online fraud which leaves traces and requires accounts for payment. Furthermore, they are able to move on before the crime is detected. Although such crime involves physically altering the ATM, most users are not able to recognize the disguised additional readers added to the ATM fascia, which are often well-made to blend in with the genuine ATM physical interface. A careful comparison with the look of a genuine ATM is needed to reveal that it has been compromised, and swift detection is needed to catch the crime during its commission. Incidents of these types of direct attacks are cyclical because preventative measures implemented by the bank will evolve with the types of attacks that have been implemented, resulting in a lag in the frequency of a particular mode of attack as the perpetrators conceive and develop new techniques of skimming. Nevertheless, it represents a significant loss to banks.

The process of skimming often results in production of counterfeit and cloned cards. The skimmed card numbers are converted to counterfeit and cloned cards that are presented at ATMs. The account numbers may be sold on the internet to crime groups and can be compromised in markets all over the world. The account owners deny involvement in any or various transactions and the banks ordinarily refund the customers.

Yet another type of direct attack is vandalism where a person or persons deliberately attack the ATM housing and enclosure with the purpose of inflicting damage, presumably with the intent of recovering money from the damaged machine. This can be a significant problem especially in areas where the bank is mandated to provide a service.

Further, attacks that occur on the user in and around the environment of the ATM may come in a variety of different forms. Theft from legitimate users is a common form of user attack.

Persons who use the ATM have cash and/or cards with them. This makes them a target for criminals looking for a quick source of cash or easily disposable goods. Shoulder-surfing is a form of attack on a user in which a criminal looks over the shoulder of the person using an ATM with the purpose of observing their PIN number. The person's card is most likely to be stolen later from the card holder and used freely in conjunction with the captured PIN number.

Another form of user attack, distraction attacks, occur when the cardholder has entered their card and pin number in the ATM. A number of people (usually two) approach the cardholder from either side. One criminal distracts the cardholder by talking loudly and deliberately to them while waving something while the other enters an amount of money to be withdrawn and extracts the money from the ATM.

A cardholder may be assaulted and robbed either during or immediately after the ATM transaction. Depending upon the circumstances and availability of other supporting materials such as local CCTV, the bank may refund the customer. This is relatively small but increasing incidence of crime. In some jurisdictions the bank are responsible for security in the area around the ATM.

Yet another form of user attack consists of coerced transactions. In this situation the cardholder is forced by another party to withdraw money from their account at an ATM against their will. This is becoming a crime of significant frequency, especially perpetrated on the more vulnerable customers of the ATM. The allegation of coerced transactions normally requires corroboration and involves law enforcement. Where the evidence supports the allegation to be bone fide, the bank may refund the customer.

Additionally, ATM fraud may also be perpetrated by the legitimate user. For example, a user may falsely deny that a transaction has taken place. The account owner disputes a transaction from a particular ATM and denies any involvement relating to a withdrawal from their account and requests a refund in full.

Another type of fraud instigated by a legitimate user is the denial that a transaction was completed. For example, the account owner admits that they tried to complete the transaction, but denies the receipt of any funds from the ATM. Their account has been deducted the amount requested from the transaction and they request a refund. An infrequent incidence, but where the account owner is persuasive (probably influential) the bank will refund the customer. This is hard to prove by either party.

ATM fraud is often undetected while in progress, and only discovered when account irregularities become apparent—usually after the criminals running the fraud have moved on to a new target ATM in another area. Even when ATM fraud is discovered, the evidence gained may be no more than a list of accounts accessed over a time period, and perhaps recovered card skimming hardware. For a successful prosecution the perpetrator must be implicated in the use of the skimming equipment and/or the cards written with skimmed data. The effect of all this is that ATM fraud is an attractive crime with a low risk of prosecution. Accordingly it is widespread, with standardized skimming hardware and modes of operation.

Current approaches to stemming ATM fraud are non-holistic in that they are reactionary after the fact. The other issue is that in a large number of cases the bank faces a scenario where they have to take someone at their word. There are very few checks and balances that can lead to prosecution or a successful check of a reported crime. A large amount of time is spent by the bank in customer relations rebuilding goodwill after an incident.

One way to deter skimming fraud is to physically attempt to prevent the installation of skimming hardware devices on a target machine. For example, this could be accomplished by adding mechanical features to the front of the ATM that physically block external access to the card reader or the numerical key pad. Such features may include, but are not limited to, three dimensional protrusions or moldings placed in strategic locations on the front of the ATM. Disadvantageously, such measures may be designed around with relative ease, and are also susceptible to vandalism.

Another way to deter skimming frauds is through the use of equipment that has the ability to disable, or block, fraudulent card reading devices installed on a target ATM machine. Such disabling devices require shielding, and are also invasive in nature.

Another way to prevent ATM fraud entails the use of video surveillance equipment. Video cameras are inexpensive, small, versatile, and can be deployed with an ordinary PC for video capture, surveillance and automated detection.

Existing video surveillance solutions have approached the problem by using high angle cameras. Disadvantageously, these cameras are not integrated with the ATM and are not correlated with the transactions that occur at the ATM. A further disadvantage of these systems is that their high angle of view makes their line of sight easy to obstruct with ordinary objects, for example, a hat or umbrella. Yet another disadvantage it that their distance from the subject tends to be too high for high resolution image capture by the video surveillance system. Among other disadvantages is that it has been common practice to run video image analysis processes on the same machine as the cameras that capture the sources. Most image analysis algorithms are computer processor intensive and may cause system instability if the algorithm is fighting with the multiple cameras for computer processor time.

### SUMMARY OF INVENTION

A method and apparatus for integrated ATM surveillance of an area of interest, such as an automated teller machine (ATM), is presented. An embodiment of the present invention includes a surveillance system for an ATM utilizing multiple cameras aimed at the user, the card slot, the cash dispenser, the surrounding areas and internally in the card reader (to link the card used to the ATM user). The cameras are constantly powered and begin to record images after a sensor is activated. An embodiment of the present invention maintains a buffer of recorded imagery such that when the sensors are activated, the video processing equipment can store a pre-defined amount of time before the sensor is activated. The buffer allows for the video capture of events just prior to the activation of the sensor. A time stamp and any other relevant data from the cameras may also be included with the stored recorded video.

According to the invention, image processing technology is used to compare images of the ATM equipment. A base image is taken and stored and a camera collects images of the machine on periodic intervals. In addition to the original image, the image processor creates a composite image built from several sample images to allow for subtle lighting changes during the course of a day (e.g. day time versus night time). The image processor then compares the newly acquired image to the original image/composite image, looking for differences in the appearance of the machine. Upon detection of a discernable alteration to monitored aspects of the machine, security is notified and the machine ceases to function.

The method and apparatus according to the invention is implemented with generic hardware components and interfacing. System capabilities are determined by software design that enhances the role of the system. According to the invention multiple video devices can be targeted to perform limited tasks efficiently, rather than video being the centerpiece of a generalized system. This enables system functions to be automated, reducing the involvement of human operators.

Real-time video processing in software, without the need for dedicated image-processing hardware, facilitates selective video feed for particular events that will trigger a further response, such as raising an alarm or initiating a recording. The method and apparatus automatically responds to a trigger event and captures selective video, extracting the event from the video feed under software control,

The system according to the invention integrates multiple surveillance modes, transaction-oriented digital recording and tamper detection. The system improves over a conventional video surveillance installation by, among other things, automatically alerting the operator when ATM fraud is detected and; by building a searchable database of transaction records for offsite use via a sophisticated client; and by being comprehensive in the volume of crime types and the method by which it records it.

Features of the invention include integration of ATM imaging and scene imaging. Simultaneous video footage is recovered of the scene around the ATM and the ATM fascia, showing the progress of a transaction with clear images of the user. The system connects transaction data to video footage. The transaction is referenced by time, and data relating to the card used and the bank account number etc. may be cross-referenced with the video. Complete coverage of a transaction is undertaken. From the approach of the customer to the ATM, every aspect of the transaction may be recorded—including images of the card used—until the customer leaves. This is bundled into a transaction record for future recovery. An image of the card is tied to transaction data and footage of the user. If skimmed cards are being used the system may tie the card to the user for evidential purposes and may be used to prove skimming.

The system according to the invention may alert an operator if the ATM appearance changes. A persistent change in the appearance of the ATM is a noteworthy event and could indicate the presence of an unauthorized card reader or camera. The system detects this and alerts an operator, including the camera picture of the ATM front which caused the alert. The advantages of this are rapid detection of ATM skimming; need for continuous monitoring of video by an operator; and the ability of the operator to remotely make a judgment of the alert's seriousness.

Multiple ATMs may be monitored remotely by a centralized operator. Information may be sent straight through to a person regardless of where they are located provided they have a communication mechanism. All video aspects of the record may be viewed by the bank, fraud departments or police forces.

### BRIEF DESCRIPTION OF DRAWINGS

The foregoing and other features and advantages of the present invention will be more fully understood from the following detailed description of illustrative embodiments, taken in conjunction with the accompanying drawings in which:

FIG. 1 shows a front view of an ATM as known in the art;

FIG. 2 illustrates a front view of an ATM with skimming hardware;

FIG. 3 illustrates an overview of the integrated ATM surveillance system according to the invention;

FIG. 4 illustrates an ATM with integrated wide angle environmental cameras;

FIG. 5 illustrates an ATM with integrated profile cameras;

FIG. 6 illustrates an ATM with integrated wide ATM cameras;

FIG. 7 illustrates an ATM with integrated card slot camera;

FIG. 8 illustrates an overview of the ATM-TV online system (ATOS);

FIG. 9 is a block diagram depicting ATOS components;

FIG. 9(a) is an illustration of an upload client of the ATOS;

FIGS. 9(b) and 9(c) are illustrations of embodiments of client viewers of the ATOS;

FIG. 10 is a diagram of ATOS interactions;

FIG. 11 is a flow diagram of camera image processing in the method and apparatus for integrated ATM surveillance;

FIG. 12 is a diagram of image file format parameters;

FIG. 13 illustrates the image processing algorithm used by a detection module according to the invention;

FIG. 14 is a flow diagram of process transaction detection software according to the invention;

FIG. 15 is a diagram of a detect alarm according to the invention; and

FIG. 16 is a diagram of a transaction record according to the invention.

### DETAILED DESCRIPTION

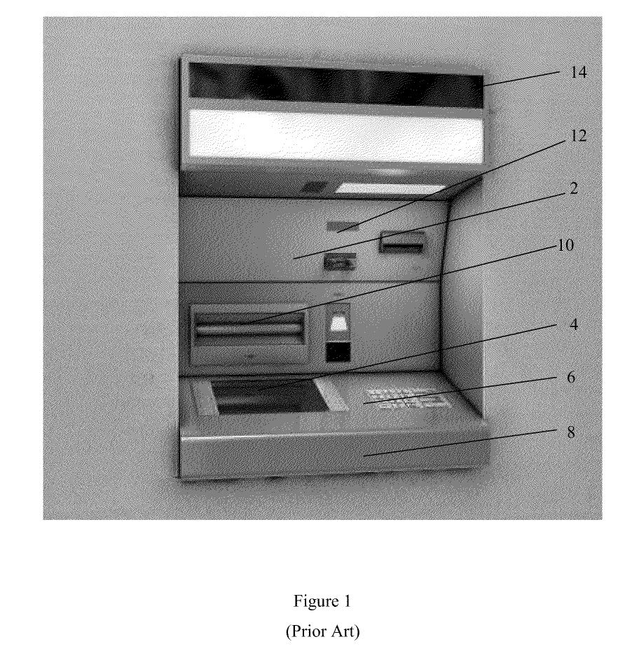

One embodiment of the invention allows for a number of cameras directed at specific aspects of the automated teller machine (ATM) and its surroundings. FIG. 1 shows the main features of an ATM front. There is a fascia (8) which is the physical interface that hides the ATM machinery. The fascia (8) contains a screen (4), a card slot (2), a number pad (6), a receipt dispenser (12), and a cash dispenser (10).

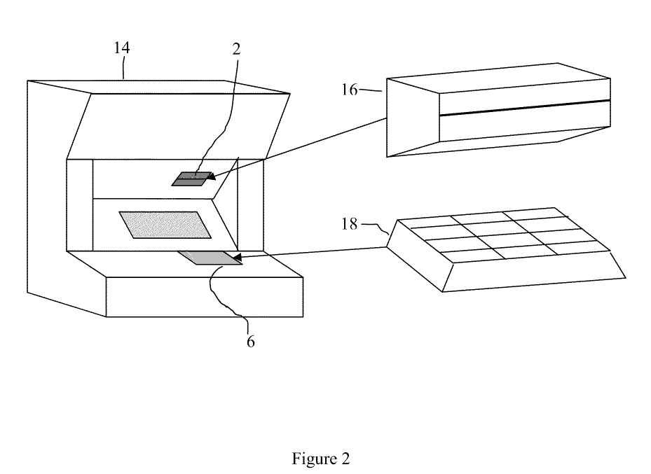

FIG. 2 illustrates an exemplary method of compromising an ATM by the addition of skimming hardware. A card skimmer (16) is added over the card slot (2) so that the magnetic data are read from a card as it is used in the ATM (14). The ATM (14) appears to work normally, but the card details have been read and stored by the card skimmer (16) in the process. At the same time, the card PIN is also recorded by a PIN skimmer (18), which overlays the normal number pad (6). The PIN skimmer (18) records the entered PIN while mechanically transmitting the key presses to the genuine number pad (6) underneath. As an alternative to the PIN skimmer (18), a camera (not shown) may be used to record video of the PIN being entered. Other implementations of this method of ATM fraud involve re-facing the ATM with a completely false front, which is able to perform all of these fraudulent functions.

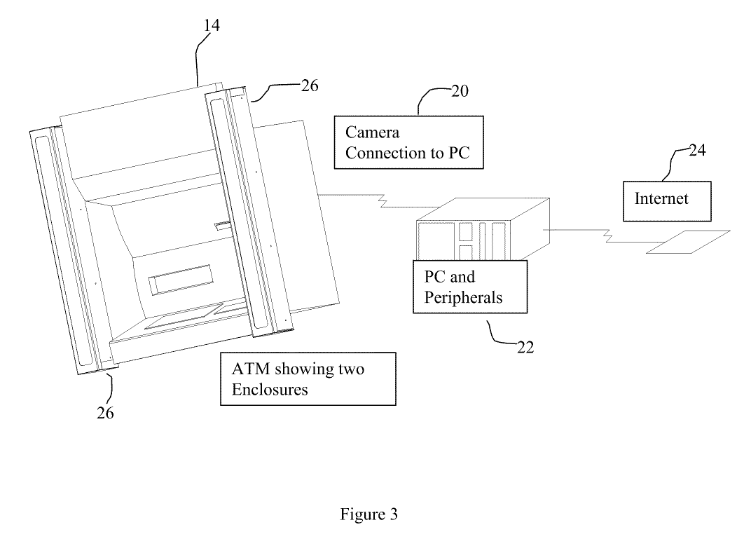

FIG. 3 is an illustrative embodiment of an apparatus and method according to the invention to prevent ATM fraud. At the ATM site there are a series of cameras and a PC with sufficient amounts of storage. Cameras are mounted in two enclosures (26) on either side of the ATM, in a variety of positions designed to image the user and the machine. Additionally, there is a further camera mounted internally in the ATM. An alternative embodiment may provide for further camera mountings in other areas of the ATM. The cameras in these enclosures (26) are connected back to a single PC (22), which is connected to the internet (24). Some or all of these camera angles may be used in any particular implementation of the method. As described further below, the range of possible camera positions may include a camera directed at the card slot in which a user would insert a bank card, a camera directed at a keypad, cameras directed at the user from the upper left of ATM and from the upper right of ATM, and/or cameras directed to the nearby area to left and right of the ATM.

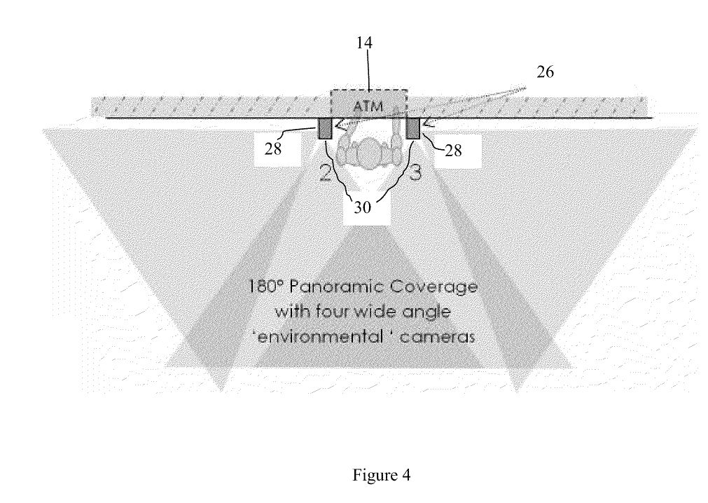

FIG. 4 shows an illustrative embodiment, in which four wide angle environmental cameras (28, 30) image the area surrounding the ATM. These cameras are fitted with wide angle (e.g. about 70°) lenses that overlap each other to give about a 180° panoramic view, thereby ensuring that anyone who approaches the ATM (14) will be captured on video, regardless of their angle of approach. Where possible these cameras (28, 30) are mounted above shoulder height in order to avoid obstruction from anyone standing at the ATM (14). The cameras (28, 30) are angled at a slightly downward facing angle in order to avoid strong lighting sources such as streetlights, the sky, and the sun.

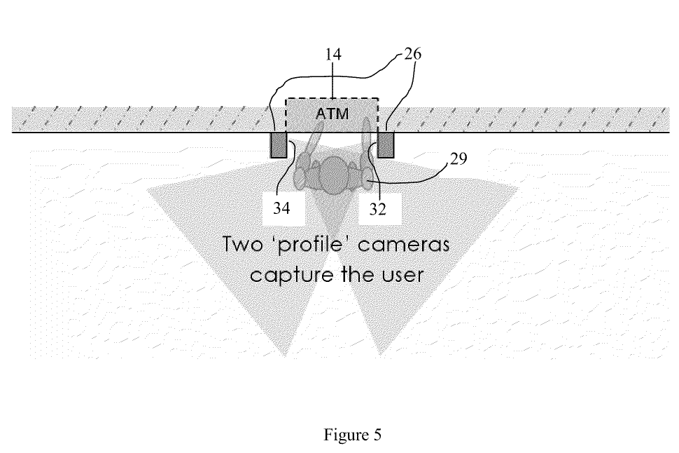

As shown in FIG. 5, there are left (34) and right (32) profile cameras, which image ATM user's in profile from either side while they are using the ATM (14). These cameras (32, 34) are used to capture images of the face of the person using the ATM. These cameras are mounted as close to the ATM as possible and point back out into the user's face. They are also rotated about 90° so the aspect ratio is biased (2:3) towards the vertical so that a greater variation in the height of user's may be captured.

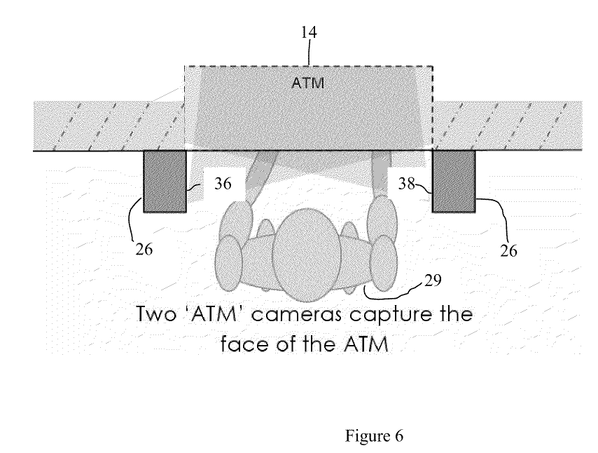

As shown in FIG. 6, an illustrative embodiment of the invention may also contain left (36) and right (38) ATM cameras pointed at the face of the ATM. These cameras (36, 38) monitor the card-slot and cash dispenser to detect the addition of a skimming device, as well as to verify the outcome of the transaction. In addition to recording the images from these cameras, additional software monitors the card-slot for changes such as a skimming device being placed in front of it.

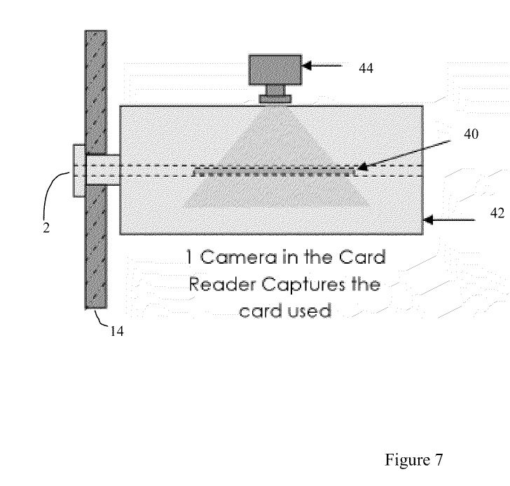

FIG. 7 show that an illustrative embodiment of the invention may also contain an internal card slot camera (44) within the card slot (2) that images the card as it travels through the ATM (14). The card slot camera (44) is used to link the card (40) used with the user, and also to timestamp the time and duration of a transaction.

In an embodiment of the present invention, cameras may be activated by a passive sensor. In particular, the cameras that are pointed at the ATM user may be turned on by a passive infrared (“IR”) sensor that detects the presence of a person in front of the ATM. In an alternative embodiment, the cameras may be activated by the insertion of a card in the ATM. The cameras remain constantly turned on and acquiring video. When the sensors are activated, the camera video streams are collected and stored as a record in a computer's memory. The stored record may be supplemented with a timestamp, and other relevant data.

An embodiment of the present invention allows for the capture of camera footage from a fixed period before activation to be included in the record. This includes in the record the video of a user approaching the ATM before inserting a bank card. The system always maintains a stored buffer of video of an appropriate length and commits it to the record along with the camera footage obtained after the sensors activate the cameras.

The cameras that are pointed at the ATM itself operate somewhat differently. In one embodiment, the cameras may look for a permanent change in the appearance of the ATM, indicating that someone has tampered with the machine. Upon detection of such a change, the system raises an alarm and either stores the video of the altered ATM appearance or transmits the live video to an operator to indicate that an unauthorized change to the machine has occurred. An embodiment of the present invention may provide for cameras pointing specifically at the ATM card slot and keypad, two areas which are frequently tampered with in a typical attack.

In one embodiment, the system may register, or learn how the ATM should normally appear. This is accomplished by capturing a still picture from each of the cameras pointed at an area of the ATM, for example the card slot and the key pad. The system then has a record of what the cameras should be seeing if the ATM has not been tampered with. These “normal” pictures may be captured during the initial setup or installation of the system. During operation of the system the cameras are constantly capturing new pictures of the ATM for comparison with the normal versions in memory. Image processing techniques, known in the art, are implemented to determine whether any changes in the images were captured.

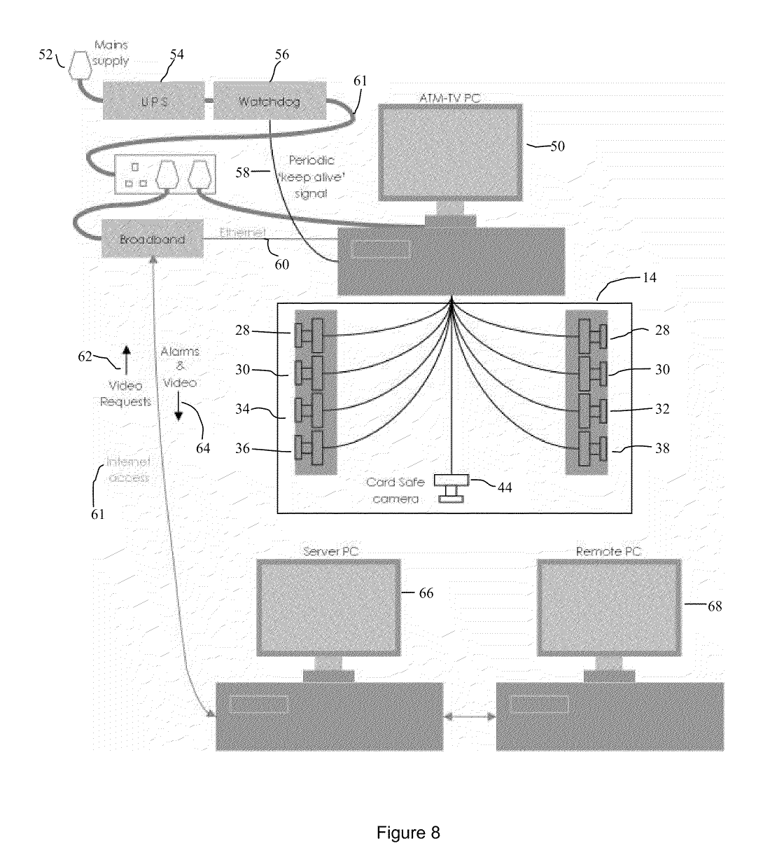

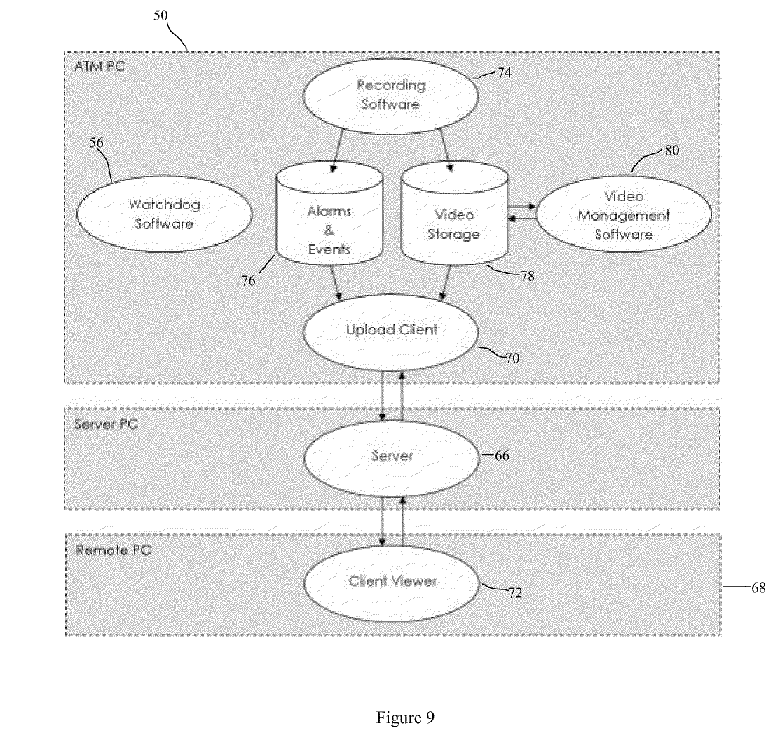

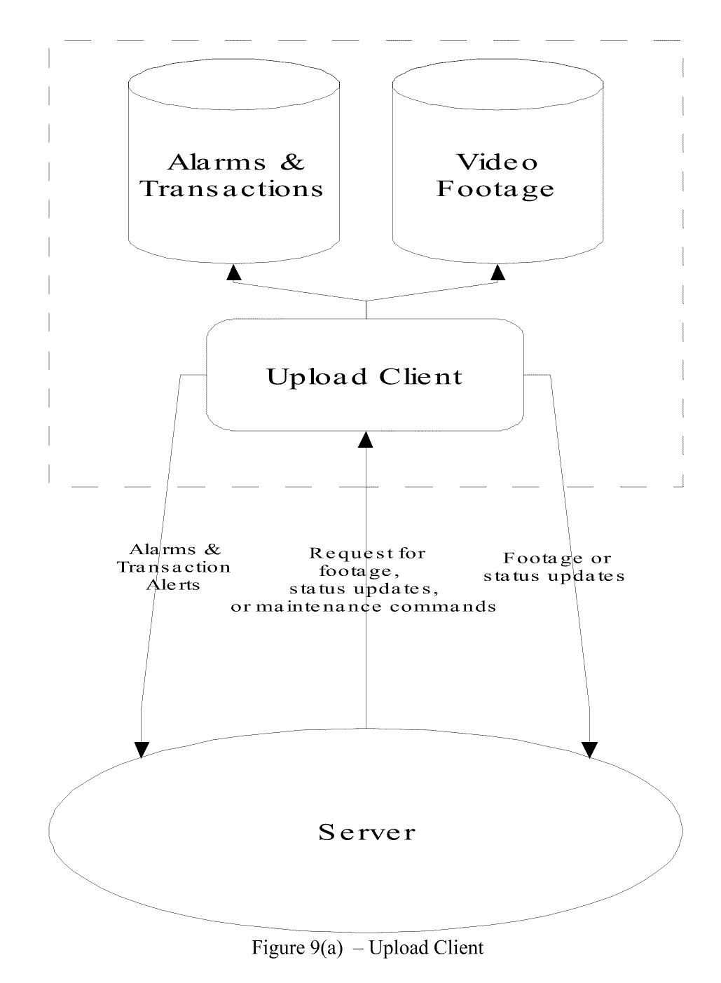

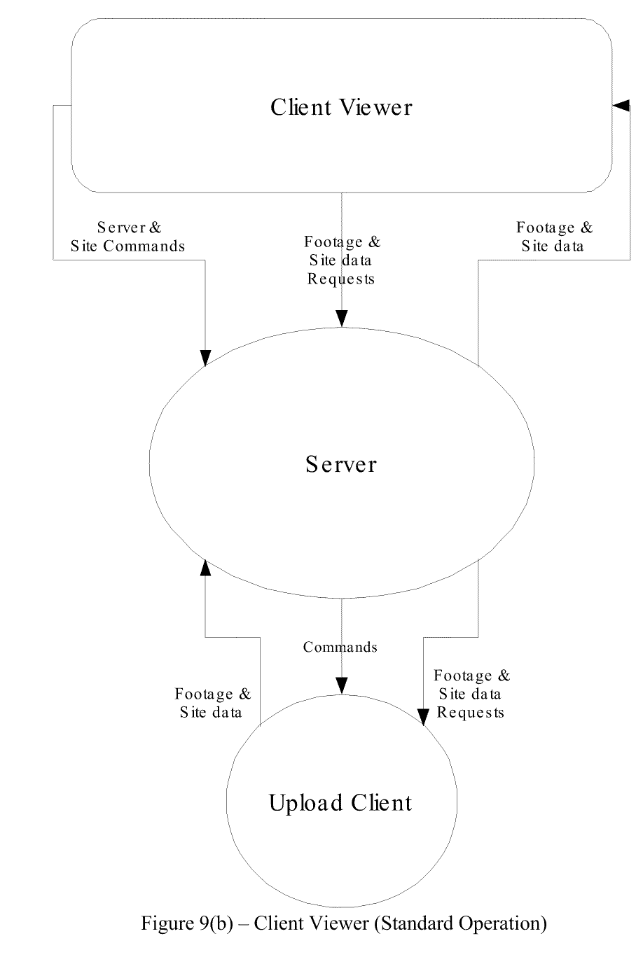

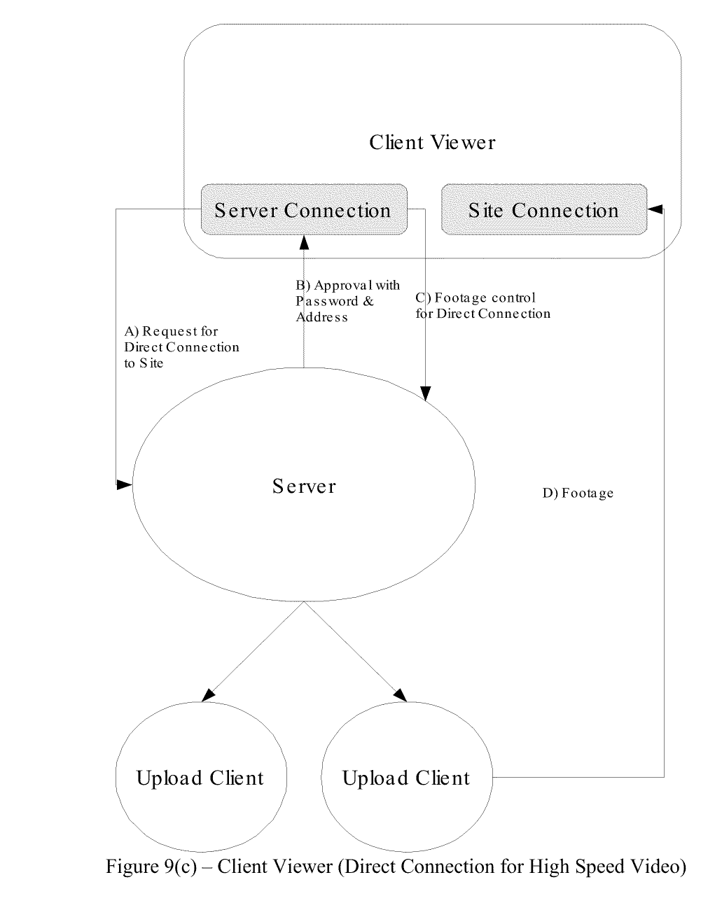

The environmental cameras, profile cameras, ATM cameras, and card slot camera described above represent the front-end of the integrated ATM surveillance system. FIGS. 8 and 9 illustrate an overview of the system according to the invention, referred to hereinafter as ATM-TV Online System (ATOS or “ATM-TV”), which represents the back-end of the integrated ATM surveillance system. The ATM (14) houses the environmental cameras (28, 30), the left (34) and right (32) profile cameras, the left (36) and right (38) ATM cameras, and the card slot camera (44), which are interfaced with an ATM-TV site PC (50) via video interface cards as known in the art. The ATM-TV site PC (50) is powered by a main power supply (52) augmented by an uninterruptible power supply (UPS) (54) that insures a constant and even flow of electricity to the ATM-TV site surveillance system PC (50). The power coupling (53) between the UPS (54) and the ATM-TV site PC (50) is monitored by a watchdog system (56) that tracks the system performance of the ATM-TV site PC (50) via a watchdog connection (58), as well as the up-time of the ATOS as a whole. In the event of a system hang or crash, the watchdog system (56) may re-boot the ATM-TV site PC (50), as well as other associated hardware and peripherals.

The ATM-TV site PC (50) is connected to the internet (61) via a standard TCP/IP (60) connection, and this connectivity allows the ATM-TV site PC (50) to interface with the ATM-TV server (66), which serves as a central hub in the ATOS as part of a server-client interaction. In an alternative embodiment, the ATM-TV server's (66) communication mechanism may use a proprietary protocol on top of TCP/IP. Messages may then be passed between the ATM-TV server (66) and a client using a series of predefined byte codes, which define a specific task.

In addition to the ATM-TV site PC (50), the ATM-TV server (66) may also interface with a remote PC (68) to enable authorized users to gain access to the system. In an illustrative embodiment, the ATM-TV server (66) may interface with ATM-TV site PC's at multiple ATM locations, as well as allow multiple remote PC's to allow multiple authorized users to interface with any of the ATM-TV site PC's in the ATOS.

The ATOS is a server-client system that uses standard TCP/IP connections as its communications base. At the heart of this system sits the ATM-TV server (66), which links to multiple ATM sites and performs monitoring and tracking duties, and also provides approved access to authorized users. As illustrated in FIG. 9, this system contains a single ATM-TV server (66) and two types of client: the upload client (70) that runs on the ATM-TV site PC (50) and the client viewer (72) that runs on any remote PC (68) in the world. The ATM-TV server (66) resides at a controlled location with access to a static IP internet connection. It may manage the connections of multiple clients. It serves as the main “hub” for all remote communications of the ATM-TV system. The ATM-TV site PC (50) may also contain functional elements including, but not limited to, recording software (74), video management software (80), capacity for video storage (78), and capacity to trigger alarm and event calls (76).

The ATM-TV server (66) provides access to the ATM-TV site PC's to remotely view videos and maintain the health of the individual ATM-TV site PC's. The ATM-TV server (66) also authenticates connections with the ATM-TV site PC's and approved client viewer's (72). The main duties of the ATM-TV server (66) include, but are not limited to, managing multiple connections from clients; authenticating user connections; storing video, logs, transaction alerts, and detect alarms; and transporting video from the ATM-TV site PC (50) to approved client viewer's (72). The ATM-TV server (66) also monitors the ATM-TV site PC (50) and is able to send email and SMS alerts to authorized users.

In an alternative embodiment, the ATM-TV server (66) may also act as a backup device for footage from an ATM site. The ATM-TV server (66) may automatically command the upload client to upload a certain amount of footage at a time, which the ATM-TV server (66) then saves to a local hard-drive. If the ATM-TV site PC (50) suffers a catastrophic breakdown, then a copy of the video footage remains on the ATM-TV server (66).

The upload client (70), illustrated in FIG. 9(a), is a client application which handles the communications between the ATM-TV site PC (50) and the ATM-TV server (66). The upload client (70) handles administrative and diagnostic commands from the ATM-TV server (66) as well as access to video files on the ATM-TV site PC (50) hard-disk.

An instance of the upload client (70) runs on the same computer as the ATM-TV video system. In this way, the upload client (70) has access to the drives containing the video footage, as well as anything else on that computer system. Coupled with the TCP/IP connection to the ATM-TV server (66), the upload client (70) may be commanded to perform administrative and diagnostic tasks remotely.

The ATM-TV site clients, basically all of the software running at the site PC (50), includes an application that connects to the ATM-TV server (66) via the internet. The duties of the ATM-TV site client include, illustratively, sending diagnostic and monitoring information about the ATM-TV site PC (50) to the ATM-TV server (66); performing administrative tasks on the ATM-TV site PC (50); accessing video files and sending them to the ATM-TV server (66); uploading and downloading files to the ATM-TV server (66); and re-booting the ATM-TV site PC (50). The application also sends transaction alerts and detection alarms to the server for further processing.

The client viewer (72) illustrated in FIGS. 9(b) and 9(c) is a client application which allows a human user to access the information stored on the ATM-TV server (66) as well as on the ATM-TV site PC (50). The client viewer (72) is an application that allows access to the ATOS for an authorized user. It may run from any remote PC (68) that has an internet connection and communicates over TCP/IP. Once the Server authenticates the user's username and password, the client viewer (72) displays a list of ATM-TV Sites that the user may visit. Through the client viewer (72), the user may download single video frames or entire video sequences from the ATM-TV Site. The duties of the client viewer (72) include, illustratively, connecting to the ATOS via the ATM-TV server (66); accessing video and image data from any ATM-TV Site that is currently connected; and receiving and viewing transactions and alarms for any given day.

In an alternative embodiment, a backup video file on the ATM-TV server (66) may also act as a cache, whereby it interrupts a client viewer's (72) command to download video from a site if the ATM-TV server (66) already possesses the requested video. In this way, the efficiency of the process may be increased for the client viewer (72) while leaving the upload client unencumbered with a video download command.

In yet another embodiment, the ATM-TV server (66) receives alarms and events (76) from the upload client (70) that the video management software (80) generates and stores them locally to the hard-drive (78). Upon receipt, ATM-TV server (66) sends a notification of the alarm or event (76) to any connected client viewer (72). Alarms and events (76) may also be generated on the server-side by any detect processes that are running on the ATM-TV server (66). The alarms and events (76) that are generated by the video management software (80) are in the form of an image file that contains a synopsis of the alarm or event (76). The timestamp for the alarm or event (76) is stored within the image as well as contained within the filename of the image file. Alarms and events (76) generated on the ATM-TV server (66) are simple notifications to the client viewer (72).

Illustratively, the client viewer (72) may run on any IBM-type PC running Windows XP or above, with an internet connection and may connect to the ATM-TV server (66) from anywhere in the world. The client viewer (72) allows the user to access the video files stored on the ATM-TV site PC (50) by using a series of messages that relay a command from the client viewer (70), through the ATM-TV server (66), to the upload client (70). The video is then returned down the line in the opposite direction.

There are two types of footage that the client viewer (72) may handle: still images and video. The client viewer (72) handles each type in very different ways. The still images may be downloaded via the normal connection to the ATM-TV server (66). The still image download starts with a request from the client viewer (72) to the ATM-TV server (66) to download images from one or more cameras, at a given time. The ATM-TV server (66) returns the images as one large image file. The file is downloaded and written to file. The client viewer (72) must then “chop” the image into separate images to display the frames from the individual cameras correctly. These images contain no frame information.

The client viewer's (72) video download capability uses the same format of footage as does the video management software (80) running on the ATM-TV site PC (50). The video is a series of image format files, concatenated together in a single file, with header and footer information regarding the frames contained within the file. The client viewer's (72) download mechanism uses the same connection as the main communications to the Server.

A video download process starts with a request from the client viewer (72) to download video from a start time for a specified duration from a particular site. Other parameters such as frame rate, image resolution, and quality are also sent. The ATM-TV server (66) sends the request to the designated site and the request is either approved or declined. Once approved, the client viewer (72) is then directed by the ATM-TV server (66) to open a new connection to the ATM-TV server (66), given a different port. The client viewer (72) then opens a new connection, authenticates with the server. Once the new connection (the relay connection) is authenticated, the client viewer (72) sends a “play” command via the original connection. The video frames then begin to download through the relay connection. The client viewer (72) is tasked to join the frames together as they come in and present them to the user. When the download is finished, or an error occurs, the relay connection is then terminated.

The client viewer (72) receives alerts via the normal connection to the ATM-TV server. They arrive as simple messages from the Server. There are two types of alerts that the client viewer (72) recognizes. The first is a “Transaction Alert”. Transaction alerts are received when the user is viewing a particular site and a transaction has been detected on the site machine. A transaction is a result of a culmination of detection processes running on the site PC that registers if a card has been inserted into the ATM. The user is then informed passively that a new transaction record has been received.

The other type of alert is an “Alarm”. An alarm is generated by the detection processes running on the site PC. An alarm is received no matter what site the user is currently viewing. The alarm is stored in a global list in memory and the user is informed of the receipt overtly. Both the “Transaction” and “Alarm” alerts may then be viewed by the user as image files.

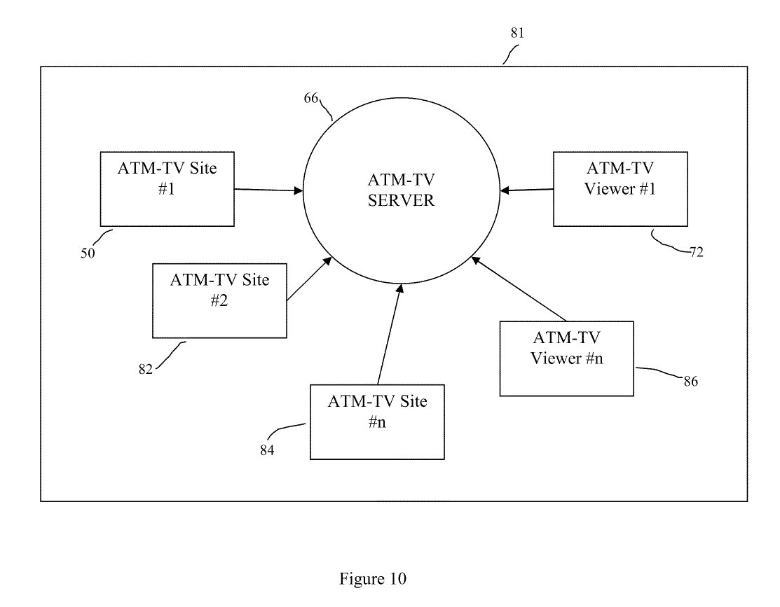

One skilled in the art should appreciate the distributive nature of the system according to the invention. As illustrated in FIG. 10, the ATOS (81) enables multiple client viewers (72, 86) to allow multiple authorized users to access multiple ATM-TV site PC's (50, 82, 84) at a variety of ATM locations. As described above, the distributive nature of the ATOS is facilitated by the central ATM-TV server (66).

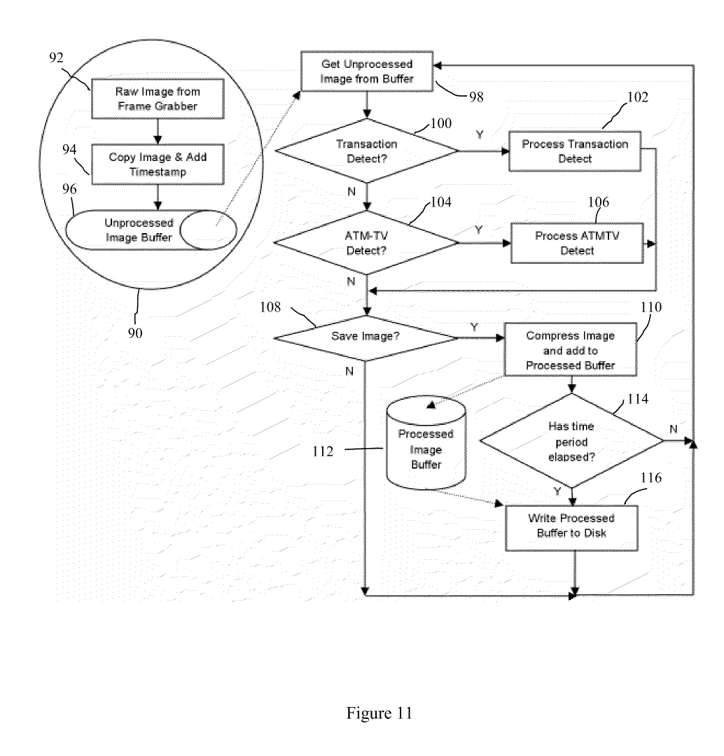

As illustrated in FIG. 11, the driver for each camera associated with a given ATM within the system has a call-back function (90) registered with it such that every raw image frame (92) that is received by a camera is passed to this function. The call-back function (90) takes the raw image frame (92) and copies the image buffer and timestamp details (94) into an un-processed buffer (96) for future processing. Each camera has a thread associated with it which polls its own unprocessed image buffer (96) for fresh raw image frames (92) from the camera. As new raw image frames (92) are time stamped and enter the unprocessed image buffer (96), older unprocessed images enter the processing module (98). Images are assessed by the transaction detection module (100) to make the binary determination as to whether or not they were generated by the card slot camera. If they were, they are assessed by the process transaction detection module (102) to determine whether or not they should be flagged for saving. If they were not, they are then assessed by the next detection module in the hierarchy, which in FIG. 11 is the ATM camera detection module (104). For the sake of clarity, FIG. 11 only depicts two such detection modules (100, 104), however, in a normal implementation of the invention a detection module may exist for every type of camera associated with a given ATM.

Images are assessed by the ATM camera detection module (104) to make the binary determination as to whether or not they were generated by the ATM camera. If they were, they are then assessed by the process ATM camera detection module (106) to determine whether or not they should be flagged for saving. An image frame is flagged for saving if either the process transaction detection module (102) or the process ATM camera module (106) determine that it is necessary to save it, or the time period determined by the selected frame rate has elapsed since the last saved frame, as determined by the elapsed time period module (114).

If the image frame is flagged to be saved, then it is parsed to a compression module (110) where it is compressed and parsed to a processed image buffer (112). Images from the processed image buffer (112) are then ready for writing out to file on the hard disk. Video images may be stored in configurable time blocks for ease of access. When a pre-determined time block has elapsed as determined by the elapsed time period module (114), the processed buffer is written out to file on the hard disk.

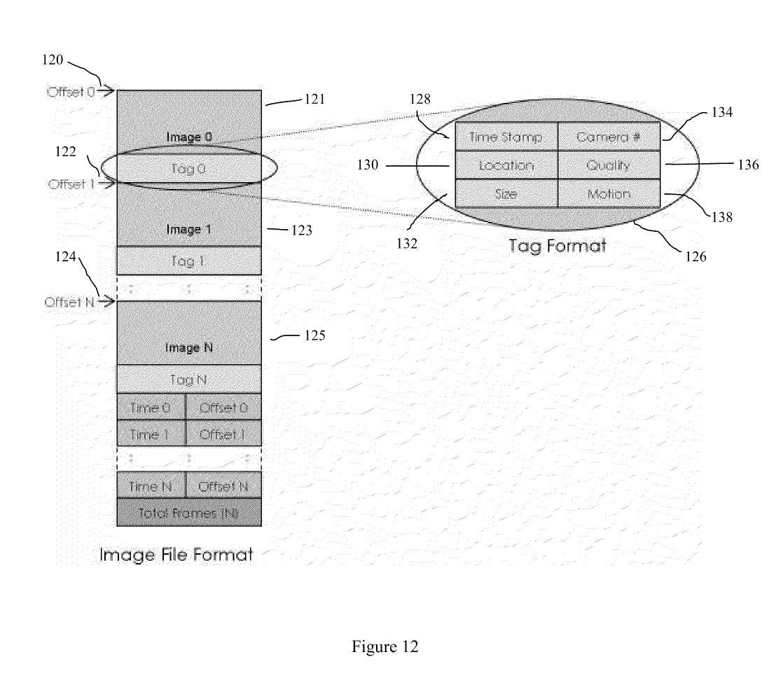

As FIG. 12 illustrates, the video from each camera associated with a particular ATM is stored as a series of still images, for example, image 0 (121), image 1 (123), and image N (125). Each still image is associated with a tag (126) that may contain a variety of data. For example, a tag may contain an individual timestamp on each frame. This is done so that synchronizing the playback of the images from multiple cameras is made easier, and also for the purpose of verification for evidence. In addition to the timestamp, tag (126) data may include the camera number (134) and site location (130) for each still image to definitively identify the time and location of each still image. Tag (126) data may also include the still image size (132) in terms of width and height, the quality of compression (136) used, and a motion value (138) determined by the offset between this frame and the previous frame. For example, offset 0 (120), offset 1 (122), and offset N (124) function to establish the video frame rate, which may be translated by an algorithm into a motion value (138). The motion value (138) is subsequently used when removing frames at a later date to reduce the amount of disk space used.

In one embodiment, the video feed may be configured such that each file contains 10 minutes of images from a single camera, thus producing 144 files per day labeled 0-143. A base configuration parameter in such an embodiment may be to store 64 days footage at a time, while dynamically overwriting the oldest files as time progresses. Depending on a user's requirements, the full frame rate and stripped frame rate storage may be varied for each site, but the current embodiment is based on a default setting programmed to store 7 days of video feed at full frame rate. After 7 days, frames are stripped out of the video in order to conserve disk space.

An alternative embodiment includes disk monitoring software that monitors disk space, and if available disk space drops below a specified limit, then the oldest video is deleted until the free space is above the limit.

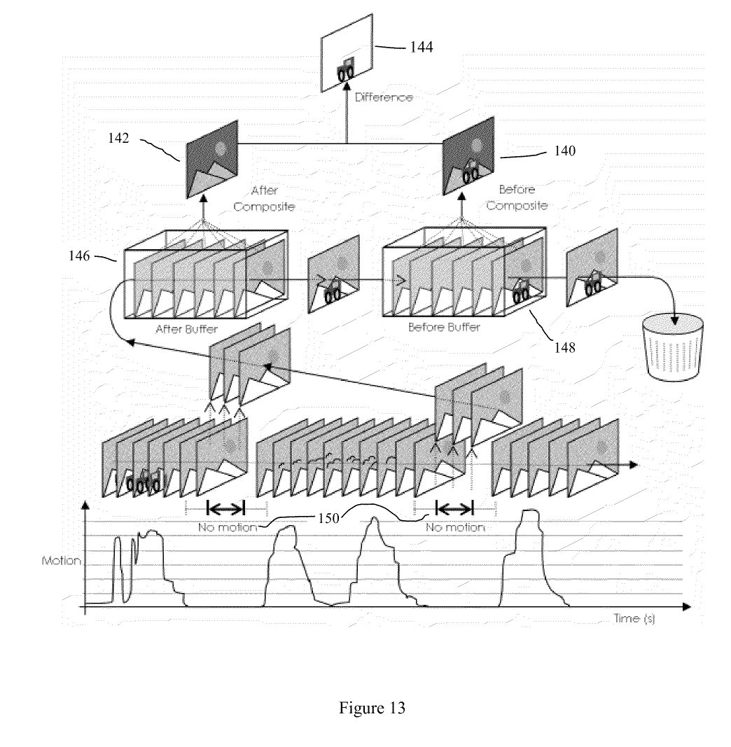

As described above in FIG. 11, the detection modules (100, 104) flag images to be saved. FIG. 13 provides a general overview of how these modules may function in an illustrative embodiment. The detection modules (100, 104) essentially work by comparing a ‘before’ composite image (140) with an ‘after’ composite image (142), and quantifying the difference between the two to produce a value of a composite image difference (144). If the value of the composite image difference (144) is above a pre-defined level, then the detection modules (FIGS. 11, 100 and 104) raise an alarm and flag the image to be saved.

One skilled in the art should appreciate that the use of composite images (140, 142) has the ability to reduce the effects of environmental lighting conditions. Under ideal circumstances, if the ATM cameras operated under controlled lighting conditions, then the comparison of before and after images would be straightforward. The system could simply save an image of the scene, and then use it as a template to compare against the most recent image. However, such idealized conditions are rarely encountered in reality. The ATOS must be able to work 24 hours a day in an outdoor environment where it is exposed to extremely dynamic lighting conditions that vary from near total darkness at night-time to direct sunlight during the day. To lessen the effect of shadows and other temporary lighting changes, the system maintains an after image buffer (146) and a before image buffer (148), each buffer containing N images where N may be a user modifiable variable for the ATOS. The system uses several images from an after image buffer (146) to build up a representation of the after image scene known as the after composite image (142). Similarly, the system uses several images from a before image buffer (148) to build up a representation of the before image scene known as the before composite image (140). Comparison of the before composite image (140) to the after composite image (142) allows the determination of the composite image difference (144).

The detection modules (FIGS. 11, 100 and 104) are keyed to detect movement in the static images within a scene. For example, these may include, but are not limited to, the card slot camera and the ATM camera. Objects that appear temporarily, for example an ATM user's hand inserting a card into the card slot, represent background noise that must be eliminated so that it does not affect the analysis of the static objects. To achieve this the detection modules (FIGS. 11, 100 and 104) look for motion in pre-determined area(s) within the scene. The detection modules (FIGS. 11, 100 and 104) only allow an image to be passed to the process detection modules (FIGS. 11, 102 and 106) if it contains a minimal motion value in the scene for N-frames before and N-frames after the frame in question, where N may be a pre-determined variable of the ATOS. One skilled in the art should appreciate that N may be varied for different ATM locations to allow for location dependent changes in lighting that may occur before an object enters the scene and also after it leaves the scene. Such changes in lighting may be due to auto white balance, auto gain control, and/or backlight compensation functions of the camera.

The process transaction detection (FIGS. 11, 102 and 106) software works by building up a before and after composite image of the static objects in front of the camera and comparing these images to determine if any of the objects have moved or changed, as generally illustrated in FIG. 13 (142 and 140).

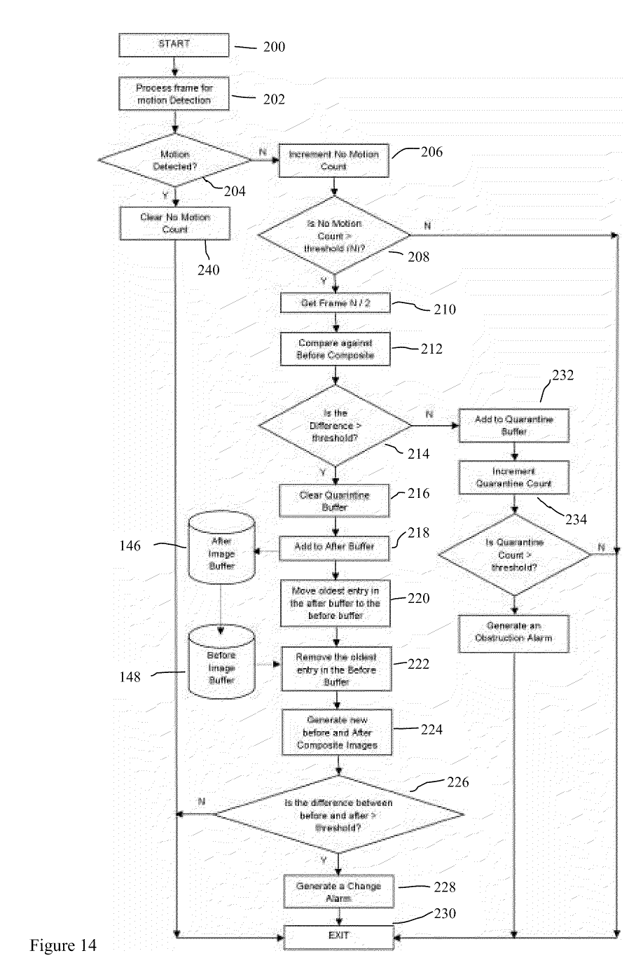

FIG. 14 illustrates the functionality of the process transaction detection software in greater detail. The system creates a score card for each component: one for the before image and one for the after image. The process starts (200) when the detection modules (FIGS. 11, 100 and 104) make the decision to parse an image(s) to the process transaction detection module (FIGS. 11, 102 and 106), which proceeds to process image frames for motion detection (202). A binary determination of whether or not motion is detected (204) is then made. If motion is detected (204), the no motion count is cleared (240) and the process routine exits (230).

If motion is not detected (204), the no motion count is incremented (206) by one and assessed to determine whether it has exceeded the value N (208), where N is a pre-determined threshold value. If the no motion count does not exceed N (208), the process routine exits (230). On the other hand, if the no motion count does exceed N (208), then the routine retrieves the image frame corresponding to N/2 (210), which is then compared to the before composite image (212) to determine whether the difference value is greater than a pre-determine threshold (214). To get the basic difference between two images a simple pixel by pixel comparison is used, and if a difference is detected using this basic method, the image may be processed by other methods (e.g. line detection) to further classify the differences (described in further detail below).

If the difference value is not greater than a pre-determined threshold (214), the image is added to the quarantine buffer (232) and the quarantine count is incremented by one (234). The quarantine count is assessed to determine whether or not it has exceeded a pre-determined threshold value (236). If the quarantine value has not exceeded that value, then the process routine exits (230); if it has exceeded that value, then the process generates an obstruction alarm (238) and then the process routine exits (230).

If the difference value is greater than a pre-determined threshold (214), the quarantine buffer is cleared (216) and the image is added (218) to the after image buffer (146). As this occurs, the oldest entry in the after image buffer (146) is moved (220) to the before image buffer (148), and the oldest entry in the before image buffer is removed (222). New composite before and after composite images are generated (224) and used to create a new composite image difference value that is assessed to determine whether the difference value is above a pre-determined threshold. If the value is not above that threshold, then the process routine exits (230). If the value is above that threshold, then the process generates a change alarm (228) prior to exiting (230).

When the oldest entry is found the frequency count corresponding to the sample value is decremented by one. The value chosen to represent the sample group is the value corresponding to the highest frequency count. In the case where two or more values have the same frequency count then the value closest to the midway point between the lowest and highest values is chosen. It is important to recognize that some frames may pass the no-motion criteria described above for reasons that are not relevant to the scene of interest. For example, an ATM user's arm blocking the camera lens for an extended period of time. To eliminate these false positives, the incoming image frame is compared against the ‘before’ composite image (212). If there is a high degree of difference between the two images we put the incoming frame into holding buffer (quarantine buffer). If we get a consecutive number (configurable) of these images we raise an alarm to signify an obstruction, otherwise we delete the ‘quarantined’ frames the next time we get an unobstructed frame.

In an alternative embodiment, the above described image processing algorithms may occur on the ATM-TV server. Advantageously, this would alleviate pressure on the computer processor of the ATM-TV site PC by performing the detection algorithms on video footage downloaded from the upload client, a real advantage when taking into account the amount of computer processor clock cycles required to manage image analysis software and video management software required to simultaneously run nine cameras at the typical ATM site. In such an embodiment, video frames may be sent to the ATM-TV server at regular intervals. On the ATM-TV server, a running process may take the video frame and compare it to the previous frame. Detect algorithms such as motion detection and skimmer detection may also be run on the ATM-TV server, which may then generate alarms or events as it sees fit.

As mentioned above, image comparisons may be facilitated by making pixel by pixel comparisons between two images. In the basic comparison method two images are compared pixel by pixel by firstly converting the pixels to grayscale (simply adding the Red, Green and Blue components together). The current pixel value is then subtracted from the previous pixel value and the absolute value of this difference is obtained. A configurable threshold value (Delta) to allow for small variations in lighting. This absolute value must exceed the configurable threshold or delta before the two pixels are considered different. If the value does exceed the delta value then its value is added to the total difference value and the total number of different pixels value is incremented. When the full image or relevant sub-section has been processed we calculate the percentage difference using the total number of different pixels value as a ratio to the total number of pixels in the image/sub-section. The average intensity of the difference, per changed pixel, is calculated by dividing the total difference value by the total number of pixels.

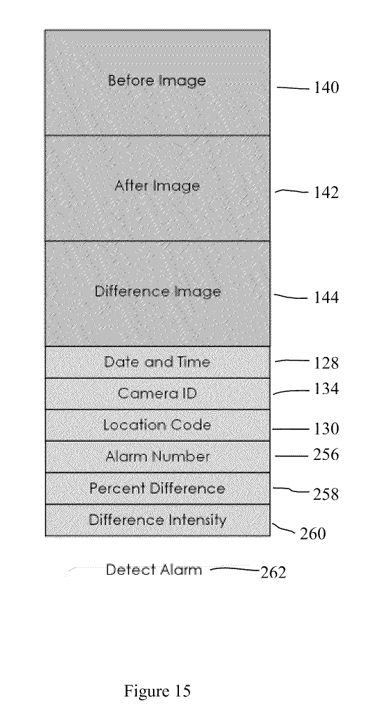

FIG. 15 illustrates the detect alarm (262), which consists of a before composite image (250), and after composite image (252), and a composite image difference (254). In addition to this image data, previously described tag data is incorporated into the detect alarm (262) including, but not limited to, the timestamp (128), camera number (134), and location (130). The detect alarm (262) further includes an alarm number (256) to uniquely identify the alarm within the system. Further information is also provided in the form of a percent difference value (258) and a difference intensity value (260) that are extracted from the composite image difference (144). These values are included to classify how big a change was detected.

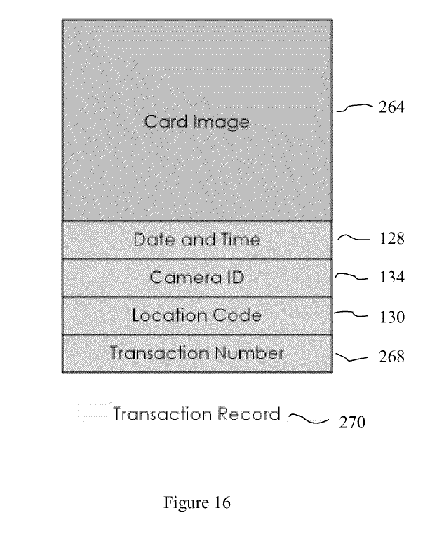

The transaction detection module (100) runs on the camera in the card reader. As described above, it uses a combination of motion detection and comparison of the current image to a template to determine when a card is present. As illustrated in FIG. 16, an image of each card (264) used in a transaction is recorded as part of a transaction record (270) along with additional information including, but not limited to, the timestamp (128), camera number (134), and location (130). A transaction number (268) is associated with each transaction record (270) to uniquely identify the transaction. The transaction record (270) may be maintained in a log for further analysis. For example, the transaction record (270) may be used for frequency analysis to determine whether a large number of transactions occurring during a period of time normally associated with low ATM user activity are associated with the use of several cloned cards. Alternatively, the transaction record (270) may be used to identify the fact that multiple cards are being used by the same ATM user as determined by the profile cameras, which may indicate suspicious activity. As another example, the transaction record (270) may be used to identify cloned cards. For example, image analysis may determine if a ‘chip’ is present on the card used. If the card slot camera determines that the card only has a magnetic stripe, then it is more likely to be a cloned card. Similarly, if the card slot camera determines that a number of magnetic stripe only cards have been presented to the ATM sequentially, then this may also indicate that a series of cloned cards are being presented. Another example where the transaction record (270) may be used is when motion activity is observed without a concomitant transaction. For instance, if the ATM and environmental cameras detect a significant amount motion over a prolonged time period without a corresponding transaction, it could indicate interference with the ATM.

While the invention has been described with reference to illustrative embodiments, it will be understood by those skilled in the art that various changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A device for processing video comprising:
a video camera focused on an area of interest,
a sensor for detecting an event in the area of interest,
a processor coupled to the camera and the sensor, the sensor signaling the processor upon detection of the event to capture data collected by the camera, said processor recording a buffer and said buffer being added to said data collected by the camera, said data collected by said camera comprising a time stamp.

2. The device of claim 1, wherein said camera captures a first image of the area of interest, the processor comparing the first image to a second image, the second image captured by the camera at a time later than the capture of the first image.

3. A method of processing video comprising:
viewing an area of interest through a video camera;
storing a collection of data captured by a video camera upon the detection of an event in the area of interest by a sensor, capturing a first image of the area of interest; and
comparing the first image to a second image of the area of interest, the second image captured at a time later than the capture of the first image.
